(19) United States
(12) Patent Application Publication
(10) Pub. No.: US 2005/0042438 A1
(43) Pub. Date: Feb. 24, 2005

(54) Flexible laminate for coating and protection of surfaces, and manufacturing method of the same

(76) Inventor: Javier Miguel Afif, Naucalpan (MX)

Correspondence Address: BRACEWELL & PATTERSON, L.L.P.;Attention: Albert B. Kimball, Jr., P.O. Box 61389, Houston, TX, 77208-1389, US

(21) Appl. No.: 10/670,076

(22) Filed: Sep. 24, 2003

(30) Foreign Application Priority Data
Aug. 21, 2003 (MX) PA/A/2003/007526

(51) Int. Cl. B32B 3/26; B32B 7/12; B32B 9/00

(52) U.S. Cl. 428/304.4; 428/317.5; 428/317.7; 428/318.4

(57) ABSTRACT

The invention herein is an antiskid and adhesive flexible laminate for coating different surfaces and the manufacturing method of the same, being such laminate characterized as consisting of two layers, one lower comprised by a non-woven material of polyester, saturated with foamed plastisol to generate an adhesive lower surface, and the other consisting on a flexible PVC decorative top film both attached by means of a PVC adhesive, and such method comprises the steps of: supplying non-woven polyester; application of foamed plastisol in the top face of such non-woven polyester; seasoning of non-woven polyester saturated with foamed plastisol in the seasoning oven; cooling of non-woven polyester saturated with foamed plastisol, once seasoned; application of adhesive in the lower face of polyester; supplying the flexible PVC decorative laminate against the lower face of polyester covered with adhesive; pressuring the laminate as a whole; accumulating the laminate; and collecting the laminate.

### BACKGROUND OF THE INVENTION

1. Field of the Invention

The invention herein relates to flexible films such as linings to coat different furniture, accessories, etc. More specifically, it relates to antiskid and adhesive flexible laminates for coating different surfaces, and the manufacturing method of the same.

2. Description of the Related Art

A great number of laminate materials have been currently developed, aimed to coat different surfaces, for example, there are different types of decorating papers known as wallpaper with different engravings and printings, which necessarily require a surface with glue or adhesive material for adhering to the surface to cover; thus, said laminate products once placed are permanent are non-removable. There are other laminate materials of plastic materials, some of them consisting on simple coating plastic sheets; nonetheless, when placed over smooth surfaces, they tend to skid and are generally unstable having skidding in the plane of surface where they are placed or overlapped there are other laminate products consisting on woven materials adhered to plastic films, these skid likewise in surfaces; there are others consisting on woven materials with foamed materials to avoid skidding; said foaming is applied to such woven materials, nonetheless, foaming separates after the application, leaving foamed areas well defined on the threads, conforming a partially adhesive surface, because it contains foaming in the threads and in the spaces between them there is no foaming; such generates a surface with homogeneous foaming distribution areas, and homogenous distribution spaces without foaming, which could result on a little adhesive surface before the uniformity of contact points with the surface covered.

Searching for previous similar inventions, we found patents U.S. Pat. No. 6,130,174 of James J. Hawley as of Oct. 10, 2000; U.S. Pat. No. 5,863,845 of Thomas Hendrix Owen, as of Jan. 26, 1999; U.S. Pat. No. 5,707,903 of Schottenfeld Herbert S. as of Jan. 13, 1998. The first of them refers to a laminate material that has the characteristic of not skidding over a surface and provides a smooth surface on the other side, which protects a laminate product that generally comprises a laminate layer of vinyl plastic, and continuously flat; a woven layer that comprises a woven material covered with foamed plastic of a compound of polyvinyl chloride and linking means of such woven layer with such flat laminated layer. This patent uses for such a woven layer covered with a foamed plastic that generates spaces between adjacent threads, forming simply widths around the woven threads and the top layer is smooth.

Regarding the second American patent located and mentioned in the previous paragraph; it refers to a non-adhesive and nonskid removable cover, which protects such removable cover for a primary surface, comprising: a substrate that has a top surface and a low surface, where at least a part of such lower surface comprises a non-adhesive and nonskid surface; and a top sheet adhered to such top surface of such substrate, where, when said nonskid lower surface of such substrate is in contact with the primary surface, the cover does not skid tangentially or laterally in relation to such primary surface, where the top sheet is a covered top sheet, and where the covered top sheet incorporates a coating that is selected from the group that consists on ink, wax, plate and a combination of all the above.

Regarding the third and last American patent mentioned above, is a nonskid decorative lining that protects a laminate lining to cover generally smooth surfaces, and the lining comprises: a nonskid cushion comprised by a material covered with a foamed polyvinyl chloride compound, to increase the extendible strength, having the cushion first and second opposed faces and a plurality of open cells extended through such cushion from the first to the second faces; said second face of the cushion comprises a frictional face fitted to hold the surface and restrict movement of the cushion in the plane of surface when the second face makes contact with the surface; said frictional face is free of adhesive substances; and a coating sheet that has a first and second opposed, said second face of the coating sheet is permanently attached to the first face of the nonskid cushion.

In general terms, the laminates that cover such patents comprise basically as substrate a woven media or material to which foaming is applied to provide it with the antiskid properties and attach to a smooth top layer through an adhesive. Nonetheless, said laminates comprise their smooth top surface and little adherence in its lower face.

### SUMMARY OF THE INVENTION

The invention herein has as a main objective to make available a flexible laminate that allows coating and protection of different surfaces, either decorative or antiskid. Another objective of the invention herein, is to provide such flexible laminate that besides avoids scratching, staining and damage of the surfaces covered.

Even another objective of the invention is to make available such flexible laminate, guaranteeing besides the smoothness of the surface covered to freely slide the items laying on the same.

And all those qualities and objectives that will be evident when carrying out a description of the invention herein, supported in the illustrated modes.

In general terms, the flexible laminate for coating and protection of surfaces, according to the invention herein, consists on a laminate of two PVC layers, one composed by a non-woven saturated polyester material with a foamed plastisol to generate an adhesive surface with the characteristic of not skidding over the surface where it is placed, and the other consisting on a decorative film of flexible PVC, smooth or texturized, both attached by means of a PVC adhesive.

Said flexible laminate is firmly adhered to the surface to cover, guaranteeing the protection and smoothness, and likewise avoids such laminate from skidding through the surface covered.

Said flexible PVC decorative film, may be engraved, printed, stamped or in its combinations.

Said flexible laminate for covering and protection of surfaces, has a thickness of about 34 or more thousandths of an inch thick.

To better understand the characteristics of the invention, the description herein is attached, as an integral part of the same, with drawings to illustrate, but not limited to that, described as follows.

### BRIEF DESCRIPTION OF THE DRAWINGS

A better understanding of the present invention can be obtained when the detailed description set forth below is reviewed in conjunction with the accompanying drawings, in which:

FIG. 1 shows a top view of the laminate for covering and protection of surfaces.

FIG. 2 shows a lower view of the antiskid substrate for coating and protection of surfaces.

FIG. 3 shows a transversal cut of the flexible laminate for coating and protection of surfaces.

FIG. 4 shows a schematic diagram of the method and devices for stamping and laminate, according to the invention herein.

FIG. 5 shows a schematic diagram of the method and devices for impregnation and melting of plastisol, according to the invention herein.

FIG. 6 shows a schematic diagram of the method and devices for attaching and conforming layers to form said flexible film, for coating and protection of surfaces, according to the invention herein.

To better understand the invention, we shall carry out the detailed description of some of the modalities of the same, shown in the drawings with illustrative but not limited purposes, attached to the description herein.

### DETAILED DESCRIPTION OF THE PREFERRED EMBODIMENTS

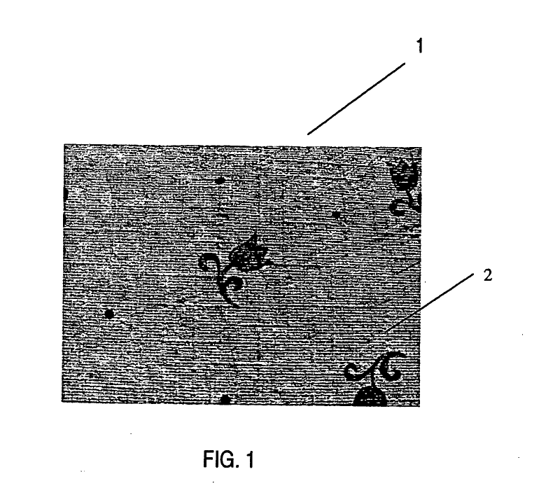

As illustrated in FIG. 1, the characteristic details of the flexible laminate for coating and protection of surfaces, are clearly shown in the following description and in the illustrative drawings attached, being the same useful as reference signs to show the same parts referred to.

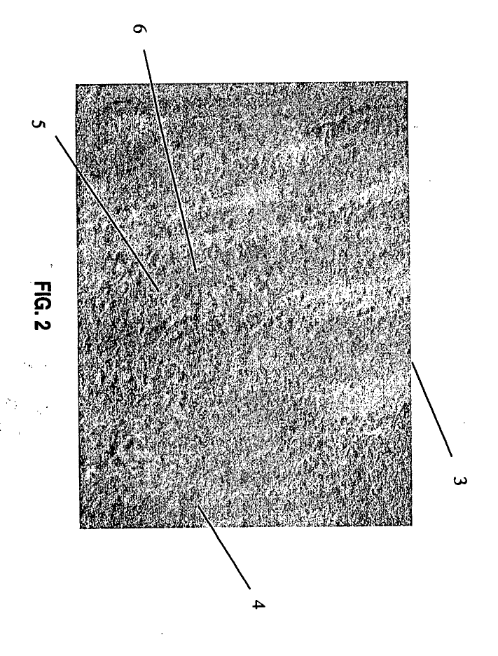

Regarding FIGS. 1 and 2 that show a top and lower view of the laminate for coating and protection of surfaces respectively. Said figure shows laminate 1, comprising a top layer consisting on a top decorative film of flexible PVC 2, smooth and preferably, as in this case, engraved, and the lower layer consisting on a continuous non-woven material 3, saturated with foamed plastisol that generates an irregular lower surface with spaces covered 5, by foam and free spaces 6, of foam, providing an adhesive surface with the characteristic of non skidding in the surface where it is placed.

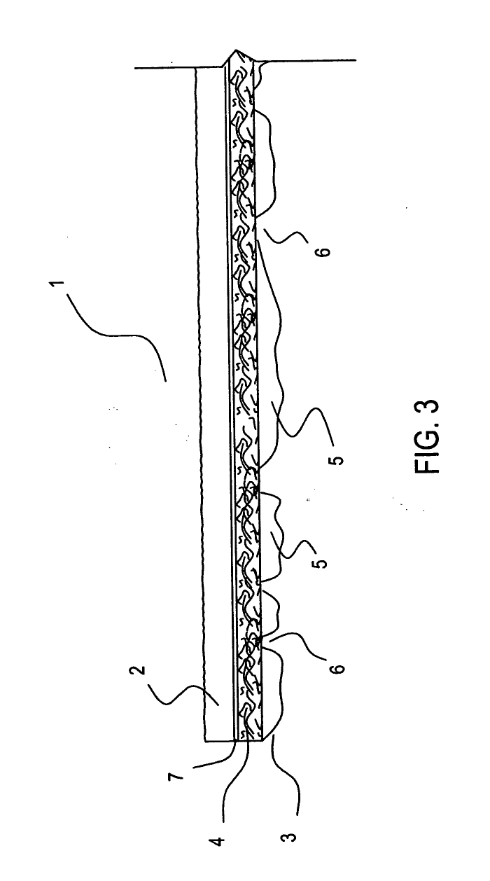

Regarding FIG. 3, showing a transversal cut of the flexible laminate for coating and protection of surfaces. In said figure, laminate 1 composed by such lower layer that is comprised by non-woven polyester 3, saturated with foamed plastisol 4; such foamed plastisol generates an irregular lower surfaces with covered spaces 5, distributed heterogeneously with said foamed material 4, and spaces 6 distributed heterogeneously, free of foamed material 4. Such layer, comprised by said non-woven material 3 saturated with foamed plastisol 4, being attached by means of an adhesive film 7 to the flexible top decorative film 2.

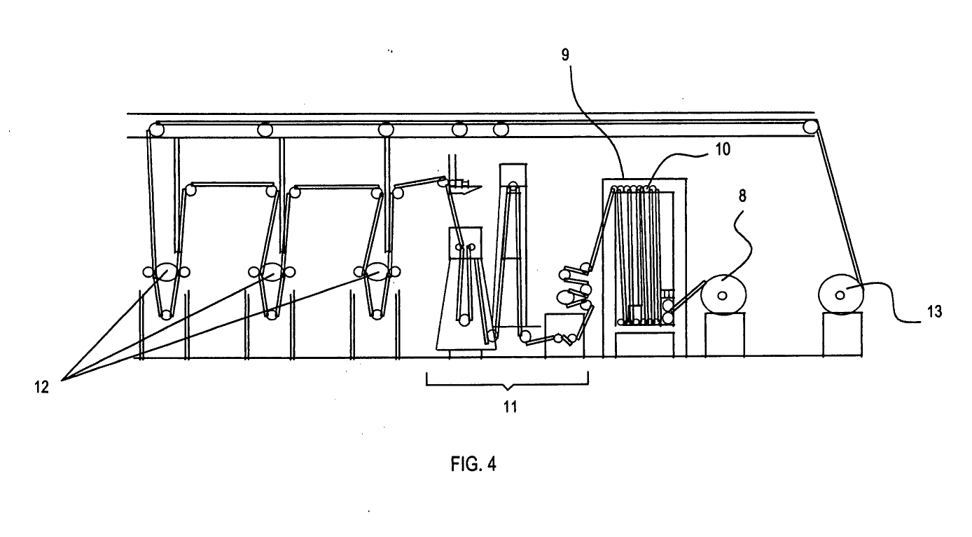

Regarding FIG. 4, showing a schematic diagram of the method and devices for stamping and laminate. In such figure, the supply spool 8, supplies the flexible PVC film 2, through an entry accumulator 9 that collects such film through accumulating rollers 10, and later to a stabilizer of film 11, then said film 2, passes through a series of stamping rollers 12, that stamp the film with different stamps, according to what is desired; the flexible PVC film 2, once stamped, is driven to a wrapping roller 13 of stamped film.

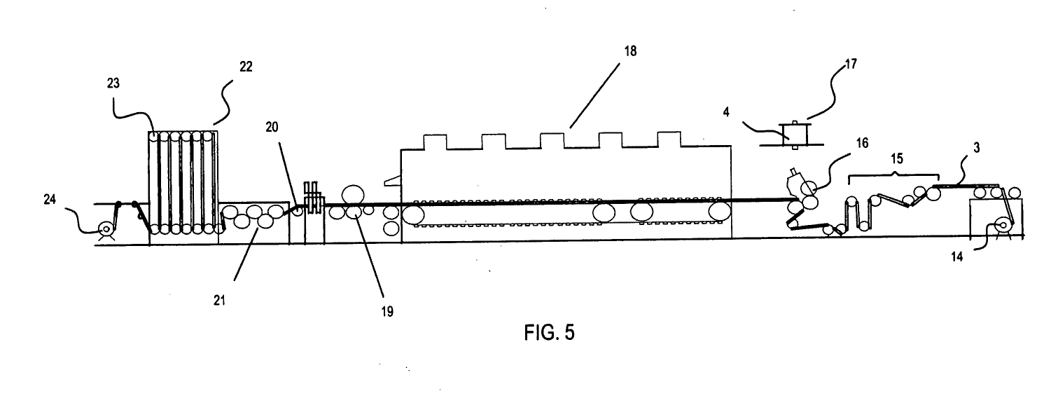

With regard to FIG. 5, showing a schematic diagram of the method and devices to impregnate and melt plastisol, according to the invention herein. Such figure supplies the non-woven polyester 3 through a roll 14, passing through lead rollers 15 that guide it to applying rollers 16 of foamed plastisol 4 from a deposit 17; once foamed plastisol is applied 4 in that non-woven polyester layer 3, it goes through an oven 18, for the corresponding seasoning. When the non-woven polyester 3, impregnated with foamed plastisol 4, goes out of the oven 18, it passes through the first cooling rollers 19, and then after lead rollers 20 to later pass through second cooling rollers 21, and from there to an accumulator 22, that gathers it through accumulating rollers 23, to later guide it to a collecting spool 24 of non-woven polyester with the foamed plastisol, making a sole film.

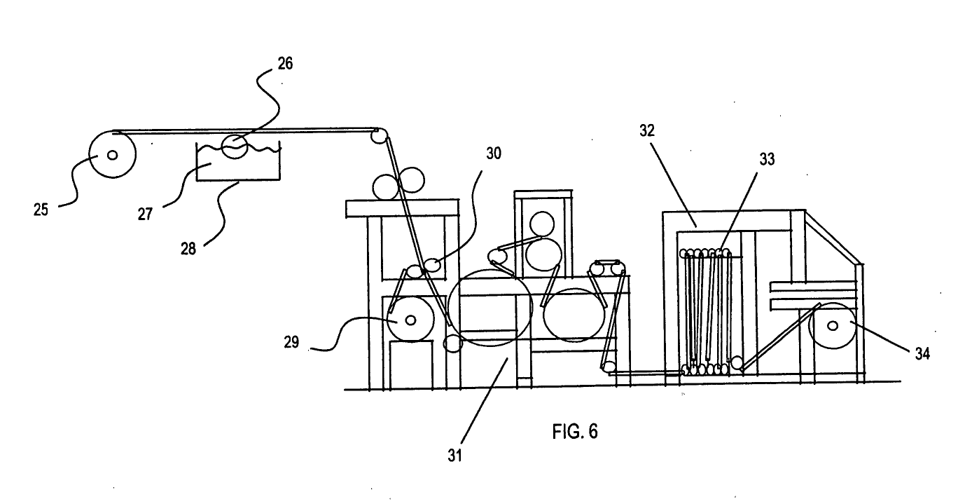

Regarding FIG. 6 that shows a schematic diagram of the method and devices to attach and conform layers for form such flexible film for coating and protection of surfaces, according to the invention herein. In such figure, non-woven polyester 3, impregnated with foamed plastisol 4, once seasoned is supplied through a roll 25, passing through an adhesive transfer roll 26, placed on the bottom, which transfers adhesive 27 from the adhesive deposit 28; then, from a supply spool 29, the flexible PVC decorative laminate 2 is unrolled and overlapped and fitted against the face of the non-woven polyester layer 3, saturated with foamed plastisol 4, covered with adhesive 27, passing through pressure rollers 30, and afterwards through a laminating devise 31, that laminates and also provides additional pressure, conforming laminate 1 according to the invention herein; such laminate passes finally through an accumulator 32, through accumulating rollers 33, and finally is driven to a finished product roll 34.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

1. A flexible laminate for coating and protection of surfaces, characterized in that it consists on two layers, a lower layer comprised by a non-woven material of saturated polyester with foamed plastisol to generate an adhesive lower surface and the other consisting on a flexible PVC decorative top film, both attached by means of an adhesive.

2. A flexible laminate for coating and protection of surfaces, according to claim 1, characterized because such flexible PVC decorative film may be engraved, printed, stamped or with a combination of the above.

3. A flexible laminate for coating and protection of surfaces, according to claim 2, characterized because it comprises a thickness of about 34 or more thousandths of an inch thick.

4. A flexible laminate for coating and protection of surfaces, according to claim 1, characterized because said foamed plastisol generates a lower irregular surface with spaces covered with foamed material, heterogeneously distributed, and spaces free of foamed material, distributed heterogeneously, providing a greater adherence capability to the surfaces to cover.

5. Manufacture method of flexible laminate for coating and protection of surfaces, comprising the steps of:
supplying non-woven polyester;
application of foamed plastisol in the top face of such non-woven polyester;
seasoning of non-woven polyester saturated with foamed plastisol in the seasoning oven;
cooling of non-woven polyester saturated with foamed plastisol, once seasoned;
application of adhesive in the lower face of polyester;
supplying the flexible PVC decorative laminate against the lower face of polyester covered with adhesive;
pressuring laminate as a whole;
accumulating laminate; and collecting laminate.
